(19) United States
(12) Patent Application Publication
(10) Pub. No.: US 2013/0212171 A1
(43) Pub. Date: Aug. 15, 2013

(54) SYSTEMS AND METHODS FOR SELECTIVE ROUTING OF REMOTE CLIENT CONTACT(S)

(71) Applicants: Richard L. Fitzgerald, Davidson, NC (US); Rosemary Hill, Jacksonville, FL (US); Kyle D. Browne, Charlotte, NC (US); Nathan Dent, Concord, NC (US)

(72) Inventors: Richard L. Fitzgerald, Davidson, NC (US); Rosemary Hill, Jacksonville, FL (US); Kyle D. Browne, Charlotte, NC (US); Nathan Dent, Concord, NC (US)

(73) Assignee: Bank of America, Charlotte, NC (US)

(21) Appl. No.: 13/370,370

(22) Filed: Feb. 10, 2012

(51) Int. Cl. G06F 15/16

(52) U.S. Cl. 709/204

(57) ABSTRACT

Methods and apparatus perform a method for electronically routing an authenticated client to a pre-determined destination. The method may include authenticating the identity of the client. In response to the authentication of the identity of the client, the method may retrieve contact information associated with the client. The contact information may include identification information for an employee listed on a list of employees pre-approved by the client. The method may further include determining the current availability of the employee for participation in a video conference. If the employee is available, the method may initiate a video conference between the client and a destination associated with the employee. If the employee is not available, the method may retrieve identification information for a second an employee listed on a list of employees pre-approved by the client.

### FIELD OF TECHNOLOGY

Aspects of the disclosure relate to video conferencing. More specifically, aspects of the disclosure relate to authenticating parties for participation in video conferencing.

### BACKGROUND

Financial institutions expend substantial resources on improving client interaction with the institution. Typically, financial institutions provide tellers, and automated teller machines (“ATMs”), in order to take care of the needs of clients. In some instances, certain banks have added branch-based video conferencing capability to certain branches in order to allow clients to access additional resources—e.g., financial institution specialist employees such as mortgage specialists, investment specialists or the like—not found at the branch office of the financial institution.

Regarding such branch-based video conferencing, security and client authorization is typically handled by branch-based bank employees.

It would be desirable to allow certain home-bound clients, such as handicapped clients and/or elderly clients, access to financial institution video-conferencing resources.

In the home setting, however, branch-based bank employees are not available for handling security and/or client authorization.

Accordingly, a need exists for systems and methods that enable a home-bound client, or even, in some circumstances such as when a branch-based bank employee is not available, a branch client to access financial institution video-conferencing resources in the absence of a branch-based bank employee.

While at least a portion of the disclosure in this patent application is directed to ATMs, it should be understood to relate to all suitable self-service devices.

### SUMMARY

A method for electronically routing an authenticated client to a pre-determined destination is provided. Such a method may include receiving authentication information from the client. The method may further include authenticating the identity of the client based on the authentication information. In response to the authentication of the identity of the client, the method may retrieve, from a database, contact information associated with the client. The contact information may include identification information for an employee with whom the client has had a previous personal interaction. The method may further determine the current availability of the employee for participation in a video conference. If the employee is available, the method may initiate a video conference between the client and a destination associated with the employee. If the employee is not available, the method may use the processor to retrieve identification information for a second employee with whom the client has had a previous personal interaction.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a flow diagram of a method for initiating a teleconference according to the invention;

FIG. 3 shows a flow diagram for another method for initiating a teleconference according to the invention;

FIG. 4 shows a flow diagram for yet another method for initiating a teleconference according to the invention;

FIG. 5 shows a flow diagram for still another method for initiating a teleconference according to the invention;

FIG. 6 shows a flow diagram for another method for initiating a teleconference according to the invention;

FIG. 7 shows a flow diagram for another method for initiating a teleconference according to the invention;

FIG. 8 shows a flow diagram for still another method for initiating a teleconference according to the invention;

FIG. 9 shows a schematic diagram of apparatus that may be used in conjunction with systems and methods according to the invention; and

FIG. 10 shows another schematic diagram of apparatus that may be used in conjunction with systems and methods according to the invention.

### DETAILED DESCRIPTION OF THE DISCLOSURE

Methods and systems for electronically routing an authenticated client inquiry to a pre-determined destination are disclosed herein. An exemplary system according to the invention may be configured to receive authentication information from a client. The system may further authenticate the identity of the client based on the authentication information.

In response to the authentication of the identity of the client, the system may retrieve, from a database, contact information associated with the client. The contact information may include identification information for an employee with whom the client has had a previous video interaction.

The system may determine the current availability of the employee for participation in a video conference. If the employee is determined by the system to be available, the system may initiate a video conference between the client and a destination associated with the employee—e.g., a video-conference equipped workstation associated with the client.

If the employee is unavailable, the system may proceed to retrieve identification information for a second employee with whom the client has had a previous video interaction. In some embodiments of the invention, a client may be associated—either through client selection, through system assignment, through personal introduction or in any other suitable fashion—a group of company employees. In such embodiments, the financial institution may internally administer an algorithm such that some member of the team is always on call for this particular client. Further, the availability of a team member may, in certain embodiments, be limited to business hours or some other pre-determined periodic duration so as to allow the client to schedule their respective video conferencing with a team member.

Following initiation of the video conference, the bank associate may help the client perform various banking services such as transfers between accounts, withdrawals, deposits, retrieval of certain banking information and other banking functions.

In certain embodiments, the video conference may use the financial institution web site for administering the video conference. Such embodiments may preferably utilize and incorporate security measures associated with the financial institution web site. Such security measures may include an online site key, password(s), etc. Additionally, security measures disclosed below may preferably be used in conjunction with already-established security protocols.

The following arrangement may be implemented in order to provide an algorithm for determining, and setting, availability of team members. Such an algorithm may include determining preferred banking associates based on parameters such as language, geographic location and other suitable parameters.

Such an exemplary availability may preferably provide one or more team members for an individual client's video conferencing needs during business hours.

| Team Member | Monday | Tuesday | Wednesday | Thursday | Friday |
|---|---|---|---|---|---|
| Janet | ON | OFF | ON | OFF | ON |
| Sam | OFF | OFF | OFF | OFF | ON |
| Roger | OFF | ON | OFF | ON | OFF |
| Fatima | OFF | ON | ON | ON | ON |

Furthermore, in certain embodiments of the invention, a threshold number of team members may be available at any given time, subject to the restrictions set forth above—e.g., during business hours. Accordingly, when one of the team members is currently unavailable, there may always be at least one possible back-up team member available for a client video conference.

In certain embodiments of the invention, the system may be configured to receive information corresponding to an identity document associated with the client. Such an identity document may include a driver's license, a passport or any other government-issued, or other officially-recognized identity document.

In some embodiments of the invention, the system may be further configured to receive identification information associated with the client's mobile phone. Such identification information may correspond to information stored in the database.

Specifically, some embodiments of the invention may include a receiver configured to receive near-field chip (“NFC”) identification information. The NFC chip may be associated with the client's mobile phone. In addition, the NFC chip may correspond to information stored in the database.

In certain embodiments of the invention, biometric information may be associated, in the database, with the client, and the system may use the biometric information to authenticate the client. Such biometric information may include fingerprint information, iris scan information or other suitable biometric information.

In certain embodiments of the invention, a photograph of the client may be associated, in the database, with the client and the system may use the photograph to help authenticate the client. In certain embodiments of the invention, the system may display the photograph, preferably a digital image associated with the client, to the employee prior to, substantially simultaneously with, or after the system initiates the video conference between the client and the employee.

Some embodiments of the invention may associate, in the database, information including a video of the client with the identity of the client. In certain embodiments of the invention, the system may display the video, preferably a set of digital images, and/or sounds, associated with the client, to the employee prior to, substantially simultaneously with, or after the system initiates the video conference between the client and the employee.

In certain embodiments, the system may perform a comparison between a digital file associated with a video (or audio) of the client to a digital file based on the live video (or audio) feed of the client during the video conference. Such a comparison may be used to further authenticate the identity of the client following the initiation of the conference, or at some other suitable point in time, or during some other suitable time period.

In certain embodiments of the invention, the receiver may be further configured to receive information corresponding to a location of the client. In such, or other, embodiments, the system may authenticate the client based on the location information.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g., air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

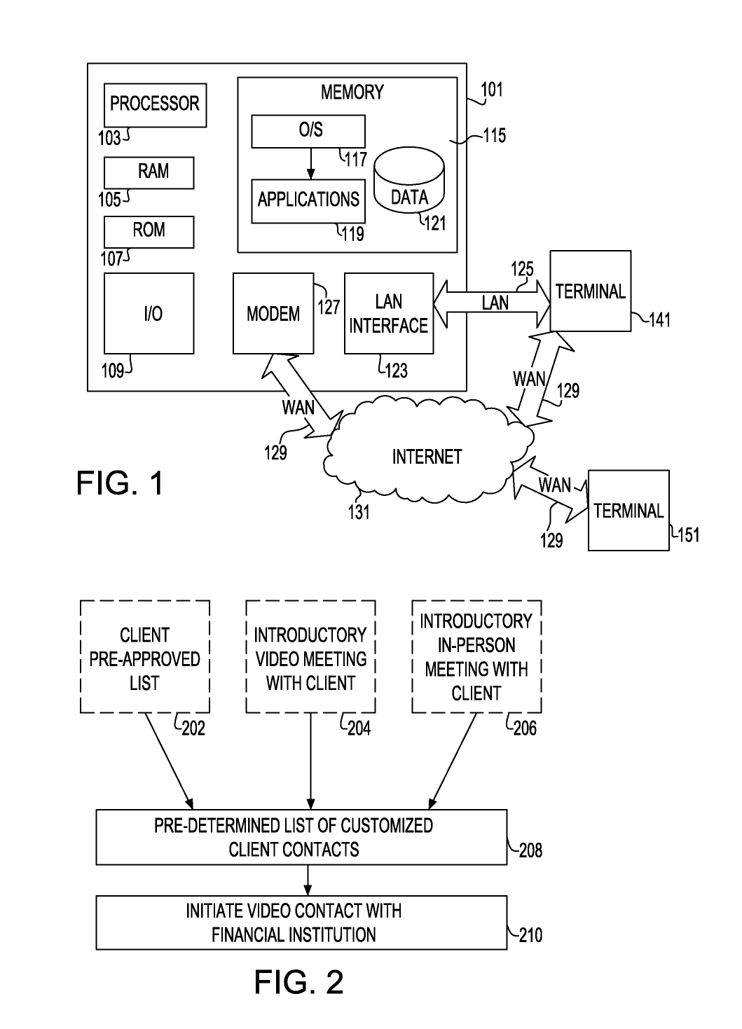

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive audio and/or video signals. Likewise, server 101 may be configured to transmit and/or receive information and to provide from/to a bank information storage system or any other suitable system.

Input/output (“I/O”) module 109 may include a microphone, keypad, touch screen, and/or stylus through which a user of device 101 may provide input, and may also include one or more of a speakers for providing audio output and a video display device for providing textual, audiovisual and/or graphical output. Software may be stored within memory 115 to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer information, authentication information, associate team member information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, smartphone, iPhone, or any other suitable device for storing, transmitting and/or transporting relevant information.

Any information described above in connection with database 121, and any other suitable information, may be stored in memory 115.

One or more of applications 119 may include one or more algorithms for determining availability of selected employees.

FIG. 2 shows a flow diagram of a method for initiating a teleconference according to the invention. Each of steps 202, 204 and 206 shows a possible source for generating a list of employee contacts. Such a list may include a list of employees that has been pre-approved by the client 202. Alternatively, such a list may include a list of employees that has been previously introduced during a video meeting with the client 204. In yet another alternative, the list may include a list of employees that has been previously introduced to the client in an introductory in-person meeting with the client.

Independent of the source of the list of employee contacts—a list may be formed at step 208. Following the concretization of the list at 208, one of the members of the list may be selected to initiate a video contact at step 210.

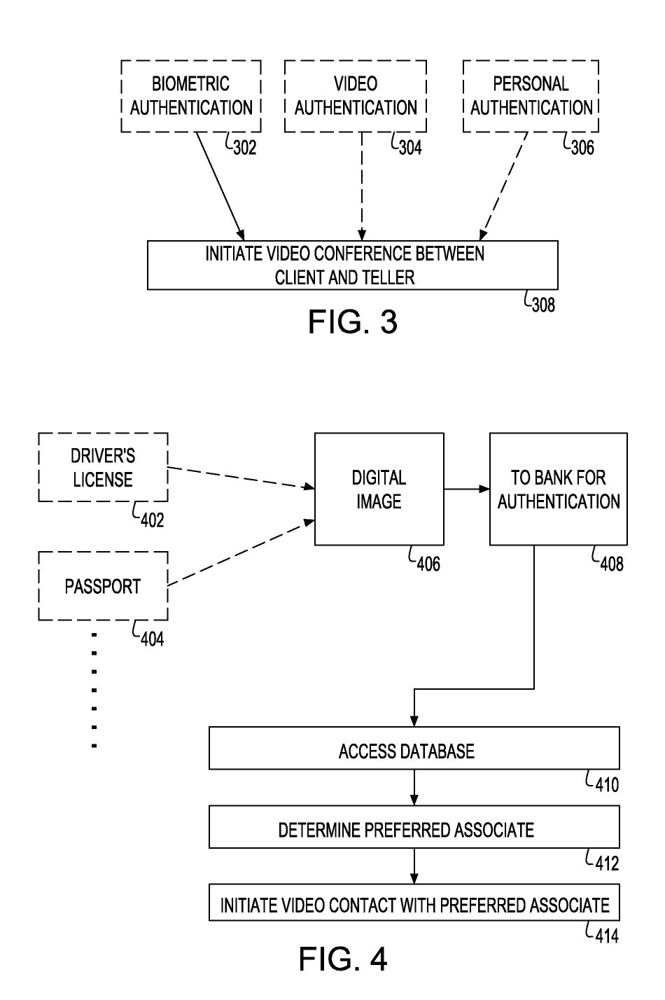

FIG. 3 shows a flow diagram for another method for initiating a teleconference according to the invention. In FIG. 3, three possible client authentication methods are provided. Step 302 shows biometrically authenticating the identity of the client prior to initiating the video conference at step 308.

It should be noted that the biometric authentication of the client may be performed by a suitable device at the site of the client. Such suitable devices may include a fingerprint analyzer, iris scanner, etc.

FIG. 4 shows a flow diagram for yet another method for initiating a teleconference according to the invention. In the flow diagram. In the method shown in FIG. 4, steps 402 and 404 show exemplary personal identification documentation associated with a client. Such documentation may include a driver's license 402, a passport 404 or other suitable documentation.

A digital file 406 may be obtained from the documentation. The digital file may include a scan of the document, information derived from a bar code on the document, information derived from a magnetic strip on the document or information derived from the document in some other suitable fashion.

The digital file may be used by the bank for authenticating the identity of the client 408. Once the identity of the client has been authenticated at step 408, a step such as accessing a database 410 may be performed.

Accessing the database 410 may preferably determine a preferred associated to participate in the video conference with the client. Such a preferred associate may be selected from a list, such as the lists shown in steps 202, 204 and/or 206, or obtained in some other suitable fashion. Once the associate is determined, the video conference may be initiated as in step 414.

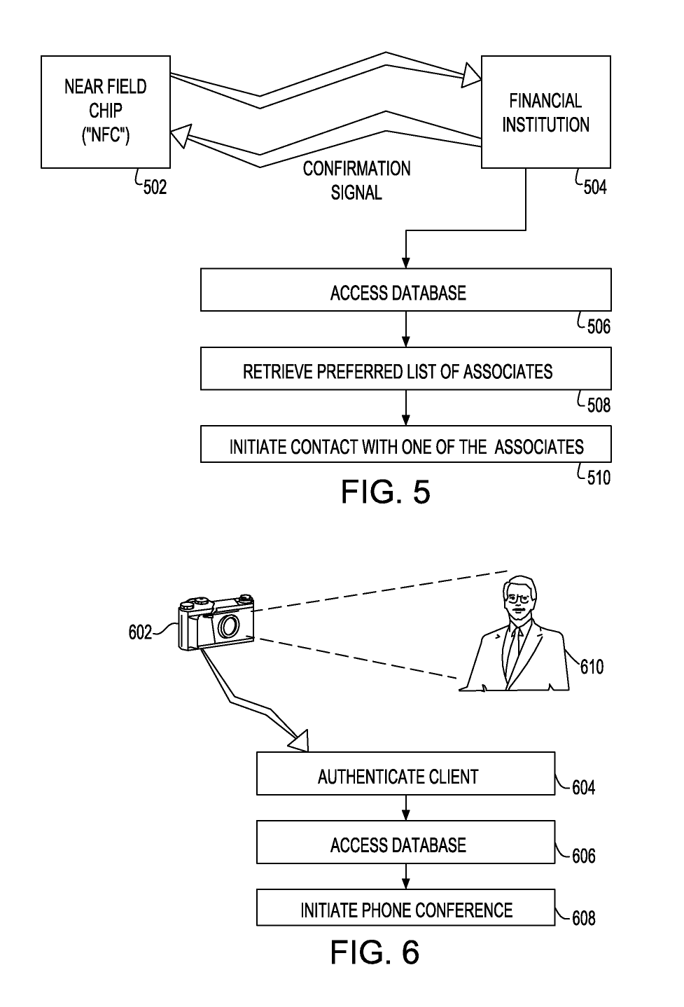

FIG. 5 shows a flow diagram for still another method for initiating a teleconference according to the invention. In FIG. 5, step 502 shows a near field chip (“NFC”) that sends an identification file and/or signal to financial institution 504. Upon receipt of the file, or at some other suitable time, financial institution 504 may send a confirmation signal back to the NFC chip or, alternatively, to the location from where financial institution 504 received the NFC information 502.

Following receipt of the file from NFC 502 at the financial institution 504, and, preferably, authentication of the file, the financial institution 504 may access database 506 in order to retrieve the preferred list of associates 508.

FIG. 6 shows a flow diagram for another method for initiating a teleconference according to the invention. Camera 602 may be used to either take a still photograph or a video recording of client 610. Such still photograph or video recording may be used to authenticate the client.

Such authentication may take the form of a comparison between a stored file associated with the client's photographic image and/or video image. Alternatively, such authentication may take the form of a display to the associate whereby the associate can compare the appearance and/or motor movements of the client during the video conference to the either a stored file which may, in certain embodiments, be displayed in a split screen with the client's present video display or to the associate's memory of the client's audio and/or video presentation.

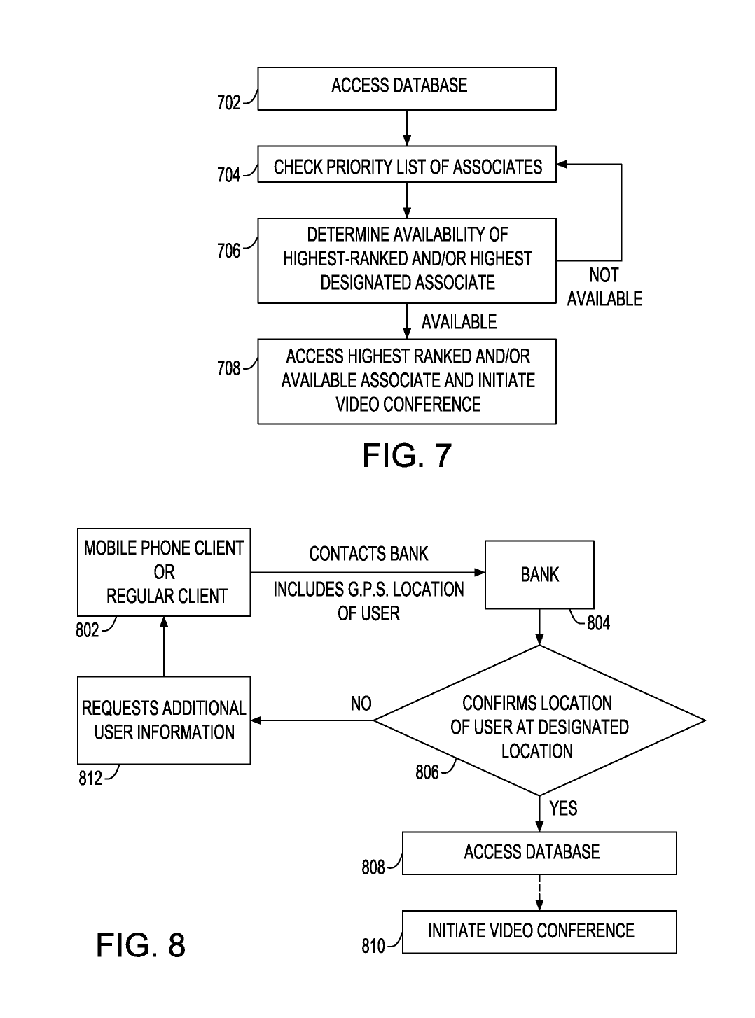

FIG. 7 shows a flow diagram for another method for initiating a teleconference according to the invention. In step 702, the method accesses a database. Typically, the method accesses the database following identification. The method may retrieve a priority list of associates at step 704. Such a list may preferably include a list of team members that have been formulated based on one of the methods shown in FIG. 2 or in some other suitable method.

Following retrieval of the priority list of associates, the system may determine the availability of the highest-ranked and/or highest designated associate. If the highest-ranked and/or highest designated associate is unavailable, the system may loop back to step 704 in order to check the next available associate on the list. If the highest-ranked and/or highest designated associate is available, then the method may continue to step 708 and access the highest-ranked and/or highest designated associate and initiate a video conference. The term designated, as used herein may also refer to a qualified and/or certified employee—e.g., an employee that has been qualified and/or certified to respond in a video conference, or in another suitable setting, with the identified client. In certain embodiments of the invention, the employee may be qualified and/or certified generally to participate in a video conference or other suitable client interaction.

FIG. 8 shows a flow diagram for still another method for initiating a teleconference according to the invention. Step 802 shows a method that originates with a mobile phone client or a regular client. Step 804 shows that the client contacts a bank, or other financial institution. The contact includes transmission of global positioning system (“GPS”) information.

The bank, or other financial institution, at step 806, confirms location of the client at a designated location. If the client's location corresponds to security information stored regarding the client's typical location(s), the method may continue to access database 808 and initiate the video conference at 810.

If the client's location does not correspond to the information stored regarding the client's typical locations, then the method may request additional information at 812 and/or loop back to the beginning of the authorization cycle at 802.

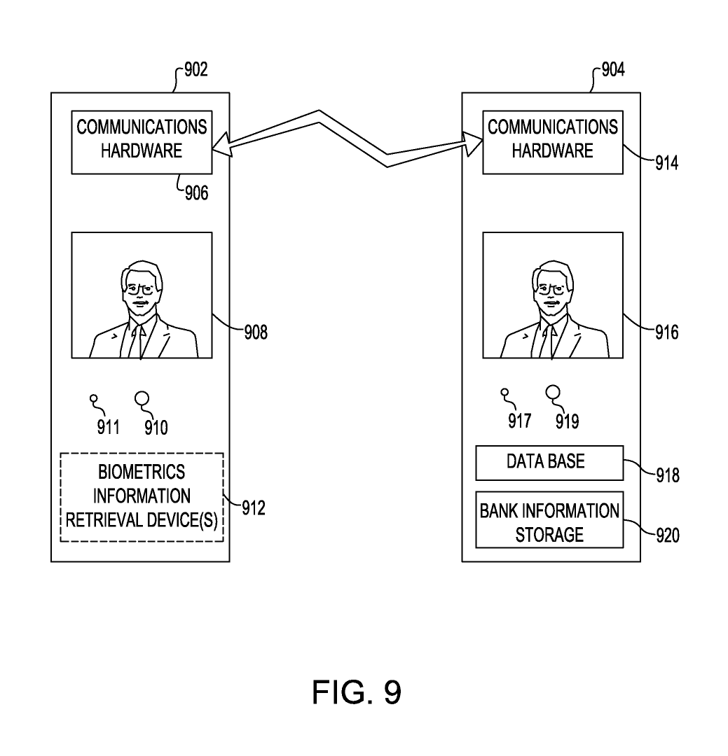

FIG. 9 shows a schematic diagram of exemplary apparatus that may be used in conjunction with systems and methods according to the invention. Client-side apparatus 902 may include communications hardware 906, a display screen 908 for displaying a video display of a bank associate, a camera 910, a microphone 911, optional biometric information retrieval device(s) 912. Bank-side apparatus 904 may include may include communications hardware 914, a display screen 916 for displaying a video display of the client, a microphone 917, a camera 919, database 918 and bank information storage 920.

In certain embodiments of the invention, the client may use one or more of the various devices associated with client-side apparatus 902 to identify him or herself to the bank associate and/or the various apparatus associated with the bank-side apparatus 904. Conversely, the bank associate may use one or more of the various devices associated with bank-side apparatus 904 to identify him or herself to the client and/or the various apparatus associated with the client-side apparatus 904.

It should be noted that the apparatus shown in FIG. 9 may be part of an internet-based system for video-conferencing. As such, the various security measures set forth with respect to FIG. 9 may be used in conjunction with the security measures already resident in internet-based financial institution systems.

Alternatively, the systems shown in FIG. 9 may exist outside the regular internet-based financial institution systems and may exist as a private, or semi-private system that cannot be accessed from the internet. Yet other embodiments of the invention may include a combination of internet-based systems and privately-administrated communication systems.

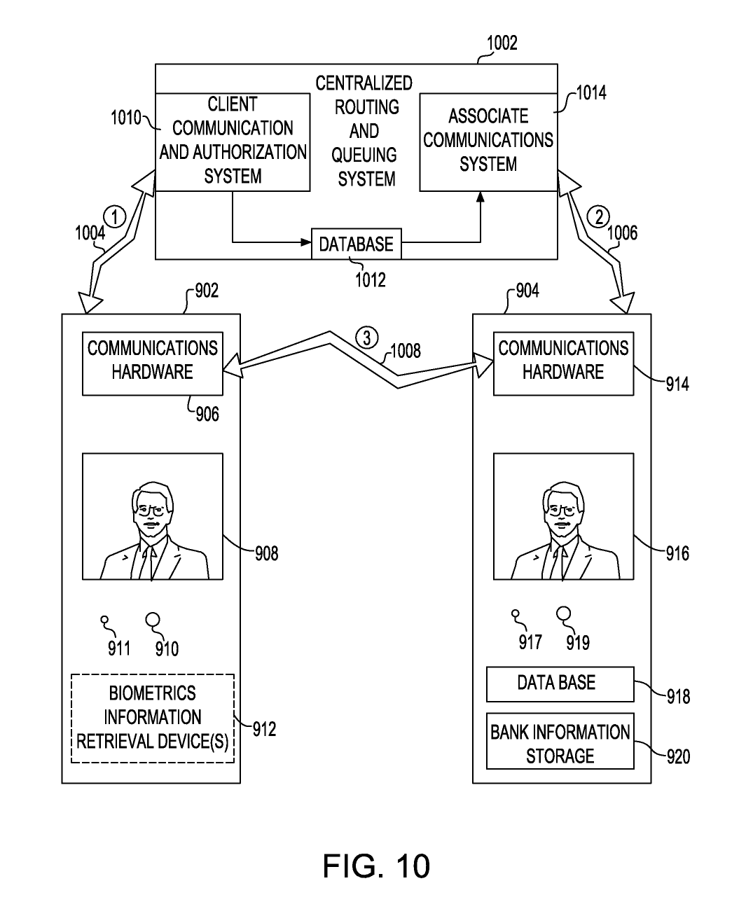

FIG. 10 shows another schematic diagram of exemplary apparatus that may be used in conjunction with systems and methods according to the invention. FIG. 10 includes a centralized routing and queuing system 1002 that may be used in conjunction with invention.

In communications in accordance with the invention, a communication from client-side apparatus 902 may be directed, at (1), to system 1002. Specifically, the communication from client-side apparatus 902 may be directed to client communication and authorization system 1010. Following identification and authorization of the client, the system 1002 may further direct the retrieval of qualified and/or certified employee information from database 1012.

Once a qualified and/or certified employee has been retrieved from database 1012, system 1002 may then utilize associate communications system 1014 to communicate with hardware 904, at (2). Thereafter, video communication, or other suitable communication, at (3), may be initiated.

Thus, exemplary apparatus and methods for using a centralized routing and queuing system 1002 for selective routing of remote client contact(s) have been provided.

Persons skilled in the art will appreciate that the present invention can be practiced by other than the described embodiments, which are presented for purposes of illustration rather than of limitation, and that the present invention is limited only by the claims that follow.

What is claimed is:

1. A method for electronically routing an authenticated client to a pre-determined destination, the method comprising:
using a receiver to receive authentication information from the client;
using a processor to authenticate the identity of the client based on the authentication information;
in response to the authentication of the identity of the client, using the processor to retrieve, from a database, contact information associated with the client, the contact information comprising identification information for an employee with whom the client has had a previous personal interaction;
using the processor to determine the current availability of the employee for participation in a video conference;
if the employee is available, using the processor to initiate a video conference between the client and a destination associated with the employee; and
if the employee is not available, using the processor to retrieve identification information for a second employee with whom the client has had a previous personal interaction.

2. The method of claim 1 further comprising using the receiver to receive information corresponding to a scanned identity document associated with the client.

3. The method of claim 1 further comprising using the receiver to receive near-field chip (“NFC”) identification information, wherein the NFC chip is associated with the client's mobile phone and the NFC chip corresponds to information stored in the database.

4. The method of claim 1 further comprising using the receiver to receive identification information associated with the client's mobile phone, wherein the identification information associated with the client's mobile phone corresponds to information stored in the database.

5. The method of claim 1 further comprising using the receiver to receive biometric information associated with the client, and using the processor to authenticate the client based on the biometric information.

6. The method of claim 1 further comprising using the receiver to receive information corresponding to a photograph of the client, and using the processor to authenticate the client based on the photograph.

7. The method of claim 1 further comprising using the receiver to receive information corresponding to a video of the client, and using the processor to authenticate the client based on the video.

8. The method of claim 1 further comprising using the receiver to receive information corresponding to a location of the client, and using the processor to authenticate the client based on the location information.

9. The method of claim 1 further comprising using the receiver to receive information corresponding to fingerprint information associated with the client, and using the processor to authenticate the client based on the fingerprint information.

10. The method of claim 1 further comprising using the receiver to receive audio information corresponding to audio information associated with the client, and using the processor to authenticate the client based on the audio information.

11. A system for electronically routing an authenticated client inquiry to a pre-determined destination, the method comprising:
a receiver for receiving authentication information from the client;
a processor for authenticating the identity of the client based on the authentication information, the processor further configured:
to retrieve from a database, in response to the authentication of the identity of the client, contact information associated with the client, the contact information comprising identification information for an employee with whom the client has had a previous video interaction;
to determine the current availability of the employee for participation in a video conference; and
if the employee is available, to initiate a video conference between the client and a destination associated with the employee; and
if the employee is not available, to retrieve identification information for a second employee with whom the client has had a previous video interaction.

12. The system of claim 11 wherein the receiver is further configured to receive information corresponding to a scanned identity document associated with the client.

13. The system of claim 11 wherein the receiver is further configured to receive near-field chip (“NFC”) identification information, wherein the NFC chip is associated with the client's mobile phone and the NFC chip corresponds to information stored in the database.

14. The system of claim 11 wherein the receiver is further configured to receive identification information associated with the client's mobile phone, wherein the identification information associated with the client's mobile phone corresponds to information stored in the database.

15. The system of claim 11 wherein the receiver is further configured to receive biometric information associated with the client, and using the processor to authenticate the client based on the biometric information.

16. The system of claim 11 wherein the receiver is further configured to receive information corresponding to a photograph of the client, and using the processor to authenticate the client based on the photograph.

17. The system of claim 11 wherein the receiver is further configured to receive information corresponding to a video of the client, and using the processor to authenticate the client based on the video.

18. The system of claim 11 wherein the receiver is further configured to receive information corresponding to a location of the client, and using the processor to authenticate the client based on the location information.

19. The system of claim 11 wherein the receiver is further configured to receive information corresponding to fingerprint information associated with the client, and using the processor to authenticate the client based on the fingerprint information.

20. The system of claim 11 wherein the receiver is further configured to receive audio information corresponding to audio information associated with the client, and using the processor to authenticate the client based on the audio information.

21. One or more non-transitory, computer-readable, media storing computer-executable instructions which, when executed by a processor on a computer system, perform a method for electronically routing an authenticated client to a pre-determined destination, the method comprising:
using a receiver to receive authentication information from the client;
using a processor to authenticate the identity of the client based on the authentication information;
in response to the authentication of the identity of the client, using the processor to retrieve, from a database, contact information associated with the client, the contact information comprising identification information for an employee listed on a list of employees pre-approved by the client;
using the processor to determine the current availability of the employee for participation in a video conference;
if the employee is available, using the processor to initiate a video conference between the client and a destination associated with the employee; and
if the employee is not available, using the processor to retrieve identification information for a second an employee listed on a list of employees pre-approved by the client.
